(19) United States
(12) Patent Application Publication
(10) Pub. No.: US 2008/0155213 A1
(43) Pub. Date: Jun. 26, 2008

(54) Data Logging and Hot Spare Device Management

(75) Inventors: John C. Elliott, Tucson, AZ (US); Robert A. Kubo, Tucson, AZ (US); Gregg S. Lucas, Tucson, AZ (US)

Correspondence Address: INGRASSIA FISHER & LORENZ, P.C. (IBM), 7010 E. COCHISE ROAD, SCOTTSDALE, AZ, 85253, US

(73) Assignee: INTERNATIONAL BUSINESS MACHINES CORPORATION, Armonk, NY (US)

(21) Appl. No.: 11/613,935

(22) Filed: Dec. 20, 2006

(51) Int. Cl. G06F 12/00

(52) U.S. Cl. 711/162; 711/114

(57) ABSTRACT

A method provides for dynamic data logging in a storage subsystem. The method determines if a plurality of storage devices has been assigned as a plurality of hot spare devices in the storage subsystem. If the plurality of hot spare devices are assigned, the method determines from the plurality of hot spare devices whether a plurality of storage types with a maximum number of spare devices is present. If a plurality of storage types is present, the method selects a hot spare device from a storage type having the smallest capacity to assign as a logging device, otherwise, the method calculates a plurality of ratios of a first number of storage devices of a shared storage type to a second number of storage devices to which the first number of storage devices can act for as hot spare devices, selecting a storage device with the lowest ratio as the logging device.

### BACKGROUND OF THE INVENTION

1. Field of the Invention

The present invention relates in general to computers, and more particularly, to an apparatus and method of dynamic data logging and hot spare device management in storage systems.

2. Description of the Prior Art

Data storage systems are used to store information provided by one or more host computer systems. Such data storage systems receive requests to write information to a plurality of data storage devices, and requests to retrieve information from that plurality of data storage devices. It is known in the art to configure the plurality of data storage devices into two or more storage arrays.

During the operation of a data storage system, it is useful to periodically collect and store product operational data such as performance data, component statistics, and operational data such as the bit error rates for component ports. The type of information is varied and the amount of data collected makes maintaining the information in a dynamic memory location temporal in nature.

It is uneconomical to attempt to provide large dedicated memory buffers for this utilization, as the historical information of interest might be several minutes to days old. In addition, the information required to analyze a problem might be information that is required after a system has failed in a manner that causes the volatile memory to be reset, cleared, or flushed. This particular class of information/data is non-essential to the operation of the storage system and in general would not cause any harm if the information were lost.

It would therefore be beneficial to provide a persistent memory location that can be dedicated to the storage of such logging data/information but not at the expense of providing unique memory just for this purpose.

### SUMMARY OF THE INVENTION

In one embodiment, the present invention is a method of dynamic data logging in a storage subsystem, comprising determining whether a plurality of storage devices have been assigned as a plurality of hot spare devices in the storage subsystem, wherein if the plurality of hot spare devices are assigned, determining from the plurality of hot spare devices whether a plurality of storage types with a maximum number of spare devices is present, wherein if a plurality of storage types is present, selecting a hot spare device from a storage type having the smallest capacity to assign as a logging device, and if a plurality of storage types is not present, calculating a plurality of ratios of a first number of storage devices of a shared storage type to a second number of storage devices to which the first number of storage devices can serve as hot spare devices, selecting a storage device with the lowest ratio as the logging device, or assigning a storage device having a storage type of the smallest capacity as the logging device if a plurality of hot spare devices are not assigned.

In another embodiment, the present invention is a system for dynamic data logging in a storage subsystem, comprising a redundant array of independent disks (RAID) controller operating on the storage subsystem, the RAID controller determining whether a plurality of storage devices have been assigned as hot spare devices in the storage subsystem, wherein if the plurality of hot spare devices are assigned, the controller determines from the plurality of hot spare devices whether a plurality of storage types with a maximum number of spare devices is present, wherein if a plurality of storage types is present, the controller selects a hot spare device from a storage type having the smallest capacity to assign as a logging device, and if the plurality of storage types is not present, the controller calculates a plurality of ratios of a first number of storage devices of a shared storage type to a second number of storage devices to which the first number of storage devices can serve as hot spare devices, selecting a storage device with the lowest ratio as the logging device, or if a plurality of hot spare devices are not assigned, the controller assigns a storage device having a storage type of the smallest capacity as the logging device.

In another embodiment, the present invention is an article of manufacture including code for dynamically data logging in a storage subsystem, wherein the code is capable of causing operations to be performed comprising determining whether a plurality of storage devices have been assigned as a plurality of hot spare devices in the storage subsystem, wherein if the plurality of hot spare devices are assigned, determining from the plurality of hot spare devices whether a plurality of storage types with a maximum number of spare devices is present, wherein if a plurality of storage types is present, selecting a hot spare device from a storage type having the smallest capacity to assign as a logging device, and if a plurality of storage types is not present, calculating a plurality of ratios of a first number of storage devices of a shared storage type to a second number of storage devices to which the first number of storage devices can serve as hot spare devices, selecting a storage device with the lowest ratio as the logging device, or assigning a storage device having a storage type of the smallest capacity as the logging device if a plurality of hot spare devices are not assigned.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an example FC-AL storage subsystem as part of an overall computer system;

FIG. 2 illustrates an example method for implementing dynamic data logging and hot spare device management in a storage subsystem according to the present invention;

FIG. 3 illustrates an example method for updating an initiator such as a fibre channel arbitrated loop (FC-AL) initiator according to the present invention; and

FIG. 4 illustrates an example algorithm which is used by a RAID controller to avoid losing logging data.

### DETAILED DESCRIPTION OF THE DRAWINGS

Some of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, punch card, flash memory, integrated circuits, or other digital processing apparatus memory device.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

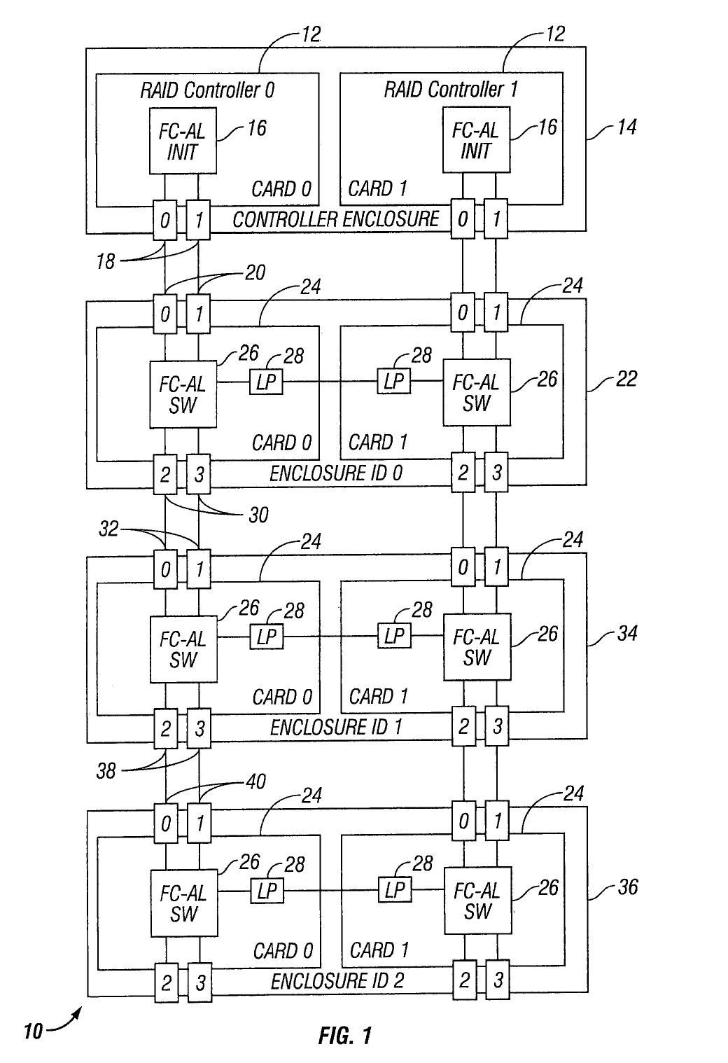

Turning to FIG. 1, an example storage system 10 with dual RAID controllers 12 connected to storage devices via a Fibre Channel Arbitrated Loop (FC-AL) storage device interconnect fabric that implements non-blocking FC-AL switches. RAID controllers 12 are enclosed by controller enclosure 14. Integrated into controller enclosure 14 are two controller cards 0 and 1 which contain a FC-AL initiator device 16. Device 16 includes downstream ports 18 denoted as 0 and 1, which communicate with upstream ports 20 of switch enclosure 22, here labeled as enclosure ID 0. Enclosure 22 also contains two FC-AL cards 24, housing a FC-AL switch 26 and a local processor 28 such as a SES processor 28, the processors 28 connected to each other. The downstream ports 30 (here labeled 2 and 3) of enclosure 22 are then daisy chained to the upstream ports 32 (labeled 0 and 1) of enclosure 34, which houses the same subcomponents as found in enclosure 22. In similar fashion, enclosure 36 also includes the same subcomponents as found in enclosure 22, with upstream ports 40 (labeled again 0 and 1) connected to downstream ports 38. Each enclosure (e.g., 22, 34, 36) provides two controller cards 24 that provide a FC-AL switch 26 and a local processor 28 (e.g., SES, see below) that is FC-AL initiator capable and has access to the FC-AL storage device network via the FC-AL switch 26.

The present invention provides for a persistent memory dedicated location which is accessible by storage device network components by utilizing a storage device that is assigned as a “hot spare” device by the RAID controller 12. Hot spare devices normally do not serve any integral system function unless there is a device failure that requires a RAID array to be repaired by a RAID controller sparing action. Thus a hot spare device is ideal for usage as a logging device for non-essential data that is temporary in nature. If a storage device failure occurs in the storage subsystem, and the logging device is required for repair by the RAID controller 12, then it is of no real consequence to subsystem 10 operation for the device to be used for the repair by the RAID controller 12.

In a switched FC-AL storage device network, such as that shown in FIG. 1, including distributed enclosures 14, 22, 34, 36 and enclosure services processors 28 (SCSI Enclosure Services [SES] Processors) that are FC-AL initiator capable, the implementation of the present invention provides an effective and efficient solution. In general, the SES processors 28 manage and control the FC-AL interface componentry (e.g., the FC-AL switch devices as previously described) and the components within each individual enclosure, and thus normally collect data and/or have the capability to access the control and status interfaces of all components of interest within the storage device network at an enclosure level. In the context of the present invention, SES processors 28 in each enclosure 22, 34, 36 collect and format data of interest and store it periodically on the storage device designated as the logging device.

The present invention includes an algorithm for the RAID controller 12 to select the storage device to designate as the logging/hot spare device, a method for the RAID controller 12 to partition the logging device such that each enclosure's SES processor 28 has a designated area of the logging device to log data, and a method of migrating the logging device between physical storage devices. The present invention is compatible with the FC-AL topology 10 as described, or is also compatible with Serial Attached SCSI (SAS) topologies, or any other type of spare storage device topology.

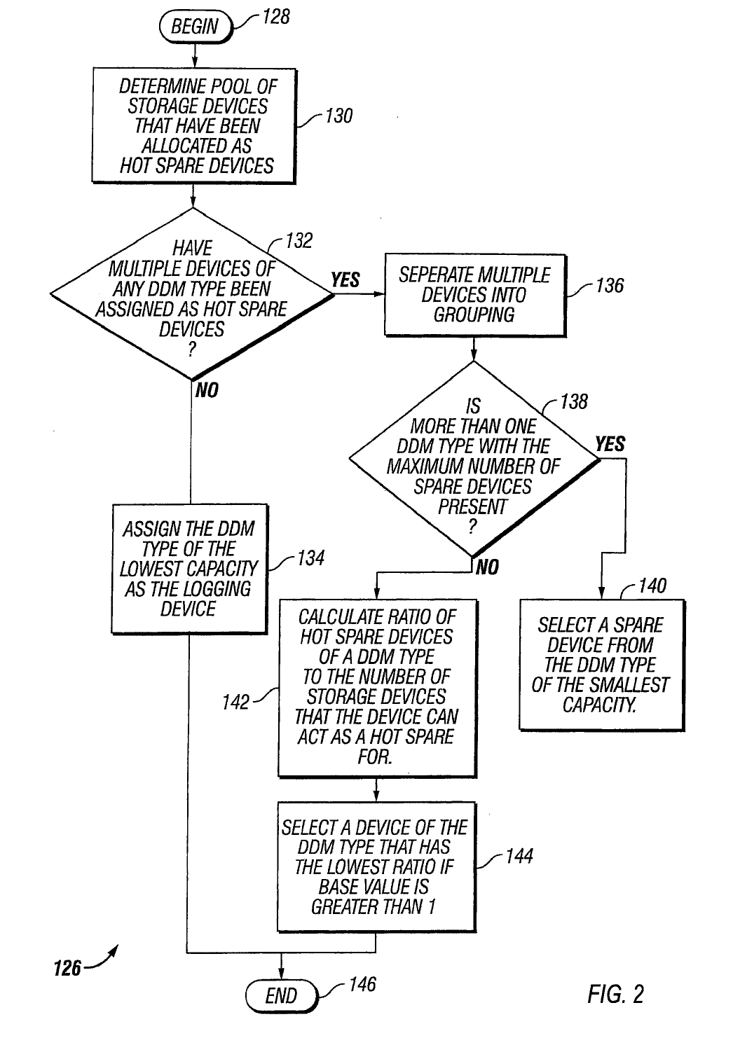

Turning to FIG. 2, an example method 126 of implementing a dynamic data logging algorithm for a RAID controller 12 to execute on a storage subsystem is shown. Method 126 begins (step 128) by the RAID controller first determining the respective pool of storage devices that have been allocated by the storage subsystem as hot spare devices (step 130). As a next step, the controller queries whether multiple storage devices of any disk drive module (DDM) type have been assigned as hot spare devices (step 132). If multiple storage devices of any storage type have not been assigned, the method 126 assigns the device having the DDM type of the lowest capacity in the storage subsystem as the logging device (step 134). If multiple storage devices of any storage type have been assigned, the method 126 separates the multiple devices into a separate grouping (step 136).

In the grouping of DDM types that have multiple hot spare devices assigned, the method 126 then queries if there is more than one DDM type with the maximum number of spare devices present (step 138). If yes, the method 126 selects a spare device from the DDM type of the smallest storage capacity (step 140) to be the logging device. If no, the method 126 calculates a series of ratios reflecting hot spare devices of varying DDM types. The ratios represent a first number of hot spare storage devices of a particular DDM type to a second number of storage devices to which the first number of storage devices can act for as hot spare devices (step 142). The method 126 then selects a storage device of a DDM type having the lowest ratio as the logging device (step 144) as long as the base value is greater than one. Method 126 then ends (step 146).

Once a hot spare storage device has been selected and designated as a logging device, a RAID controller 12 can partition the logging device such that each initiator 16 (integrated into the RAID controller) logging to the storage device has an independently owned area of the device to store its data. The partitioning of the device does not have to be a physical partitioning of the device. The portioning function can include something as simple as assigning a logical block addressing (LBA) range to each device.

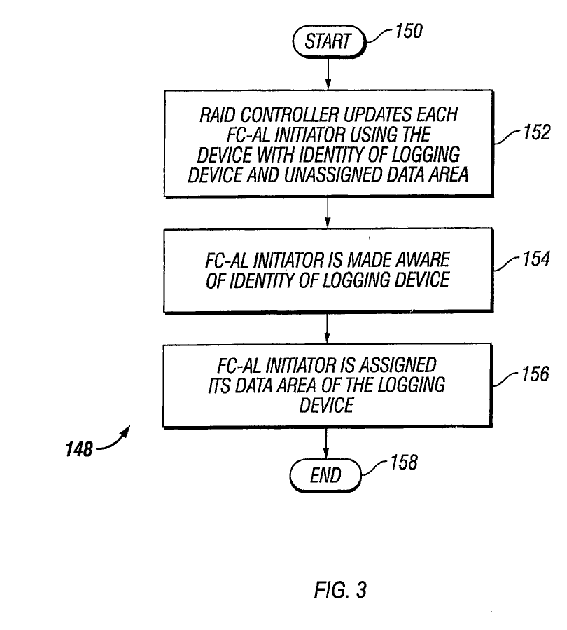

Method 148 shown in FIG. 3 depicts an example updating of an initiator such as a fibre channel arbitrated loop (FC-AL) initiator 16 according to the present invention. Method 148 begins (step 150) with the RAID controller 12 updating each FC-AL initiator 16 using the selected logging device with the identity of the logging device and the respective assigned data area of the logging device (step 152). Each respective FC-AL initiator 16 is made aware of the identity of the logging device (step 154). As a next step, a respective FC-AL initiator 16 is assigned its respective data area of the logging device (step 156). Method 148 then ends (step 158).

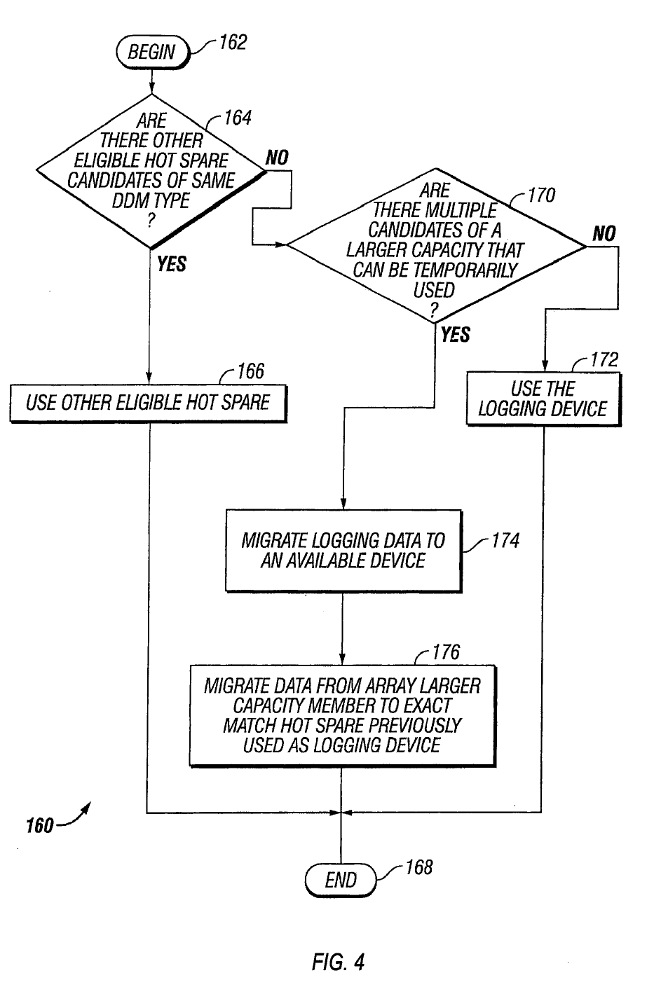

If multiple hot spare devices exist in the storage system, when a DDM failure initially occurs, a hot spare will automatically be taken by the RAID controller 12. Initially, if possible, the RAID controller 12 will use an algorithm such as the example algorithm shown in method 160 (FIG. 4) to avoid losing the logging data. Method 160 begins (step 162) by the RAID controller 12 querying whether there are other eligible hot spare candidates of the same DDM type as the logging device (step 164). If yes, the eligible hot spare candidate is utilized as the logging device (step 166) and method 160 ends (168). If no other eligible hot spare candidates of the same DDM type exist, the method 160 queries whether there are multiple candidates of a larger capacity that can be temporarily used (step 170). If no, then the respective hot spare device originally taken by the RAID controller 12 is used as the logging device (step 172). If yes, then one of the larger capacity candidates is used as the hot spare. In that case, the logging data is migrated to an available device (step 174). Additionally, data from the array larger capacity member is migrated to the exact match hot spare which was previously used as the logging device (step 176). Method 160 then ends (again, step 168).

Software and/or hardware to implement the methods 126, 148, and/or 160 previously described, such as the described migration of logging data to an available storage device as seen in step 174 of method 160, FIG. 4, can be created using tools currently known in the art. The implementation of the described system and method involves no significant additional expenditure of resources or additional hardware than what is already in use in standard computing environments utilizing RAID storage topologies, which makes the implementation cost-effective.

Implementing and utilizing the example systems and methods as described can provide a simple, effective method of providing dynamic data logging and hot spare device management in a computing environment having storage systems and subsystems as described, and serves to maximize the performance of the storage system. While one or more embodiments of the present invention have been illustrated in detail, the skilled artisan will appreciate that modifications and adaptations to those embodiments may be made without departing from the scope of the present invention as set forth in the following claims.

What is claimed is:

1. A method of dynamic data logging in a storage subsystem, comprising:
determining whether a plurality of storage devices has been assigned as a plurality of hot spare devices in the storage subsystem; and
if the plurality of hot spare devices has been assigned, determining from the plurality of hot spare devices whether a plurality of storage types with a maximum number of spare devices is present, and further,
if a plurality of storage types is present, selecting a hot spare device from a storage type having the smallest capacity to assign as a logging device,
if a plurality of storage devices is not present, calculating a plurality of ratios of a first number of storage devices of a shared storage type to a second number of storage devices to which the first number of storage devices can serve as hot spare devices, and selecting a storage device with the lowest ratio as the logging device;
or,
if the plurality of hot spare devices is not assigned, assigning a storage device having a storage type of the smallest capacity as the logging device.

2. The method of claim 1, further including partitioning the logging device once the logging device has been assigned.

3. The method of claim 2, wherein partitioning the logging device is performed such that each initiator connecting to the logging device is given an independently-owned area of the logging device to store data.

4. The method of claim 2, wherein partitioning of the logging device further includes assigning a logical block addressing (LBA) range to the logging device.

5. The method of claim 3, wherein a RAID controller updates each initiator to make the initiator aware of an identity of the logging device and to assign a data area of the logging device.

6. The method of claim 1, wherein upon a storage device failure if a storage type of a failed storage device is shared by the logging device:
selecting an eligible hot spare device other than the logging device having the shared storage type if the eligible hot spare device is found, otherwise
selecting a hot spare device of a larger capacity as a temporary data repository, the hot spare device having the shared storage type;
migrating logging data to a first available storage device; and
migrating data from the hot spare device of the larger capacity to the logging device.

7. A system for dynamic data logging in a storage subsystem, comprising:
a redundant array of independent disks (RAID) controller operating on the storage subsystem, the RAID controller determining whether a plurality of storage devices has been assigned as a plurality of hot spare devices in the storage subsystem, wherein if the plurality of hot spare devices are assigned:
the controller determines from the plurality of hot spare devices whether a plurality of storage types with a maximum number of spare devices is present, wherein if a plurality of storage types is present:
the controller selects a hot spare device from a storage type having the smallest capacity to assign as a logging device, and if a plurality of storage types is not present:
the controller calculates a plurality of ratios of a first number of storage devices of a shared storage type to a second number of storage devices to which the first number of storage devices can serve as hot spare devices, selecting a storage device with the lowest ratio as the logging device;
or, if a plurality of hot spare devices are not assigned, the controller assigns a storage device having a storage type of the smallest capacity as the logging device.

8. The system of claim 7, wherein once the logging device has been assigned, the controller partitions the logging device.

9. The system of claim 8, wherein partitioning the logging device is performed such that each initiator connecting to the logging device is given an independently-owned area of the logging device to store data.

10. The system of claim 8, wherein partitioning of the logging device further includes assigning a logical block addressing (LBA) range to the logging device.

11. The system of claim 9, wherein the controller updates each initiator to make the initiator aware of an identity of the logging device and to assign a data area of the logging device.

12. The system of claim 7, wherein upon a storage device failure if a storage type of a failed storage device is shared by the logging device:
the controller selects an eligible hot spare device other than the logging device having the shared storage type if the eligible hot spare device is found, otherwise
the controller selects a hot spare device of a larger capacity as a temporary data repository, the hot spare device having the shared storage type;
the controller migrates logging data to a first available storage device; and
the controller migrates data from the hot spare device of the larger capacity to the logging device.

13. A computer program product comprising:
a computer usable medium including computer usable program code for dynamically data logging in a storage subsystem, the computer program product including;
computer usable program code for determining whether a plurality of storage devices has been assigned as a plurality of hot spare devices in the storage subsystem; and
if the plurality of hot spare devices has been assigned, computer usable program code for determining from the plurality of hot spare devices whether a plurality of storage types with a maximum number of spare devices is present, and further,
if a plurality of storage types is present, computer usable program code for selecting a hot spare device from a storage type having the smallest capacity to assign as a logging device,
if a plurality of storage devices is not present, computer usable program code for calculating a plurality of ratios of a first number of storage devices of a shared storage type to a second number of storage devices to which the first number of storage devices can serve as hot spare devices, and selecting a storage device with the lowest ratio as the logging device;
or,
if the plurality of hot spare devices is not assigned, computer usable program code for assigning a storage device having a storage type of the smallest capacity as the logging device.

14. The computer program product of claim 13, further including computer usable program code for partitioning the logging device once the logging device has been assigned.

15. The computer program product of claim 14, wherein computer usable program code for partitioning the logging device is executed such that each initiator connecting to the logging device is given an independently-owned area of the logging device to store data.

16. The computer program product of claim 14, wherein computer usable program code for partitioning of the logging device further includes computer usable program code for assigning a logical block addressing (LBA) range to the logging device.

17. The computer program product of claim 15, further including computer usable program code to instruct a RAID controller to update each initiator to make the initiator aware of an identity of the logging device and to assign a data area of the logging device.

18. The computer program product of claim 13, wherein upon a storage device failure if a storage type of a failed storage device is shared by the logging device, the computer usable program code causes the following operations to be further performed including
selecting an eligible hot spare device other than the logging device having the shared storage type if the eligible hot spare device is found, otherwise
selecting a hot spare device of a larger capacity as a temporary data repository, the hot spare device having the shared storage type;
migrating logging data to a first available storage device; and
migrating data from the hot spare device of the larger capacity to the logging device.
